(19) United States
(12) Patent Application Publication
(10) Pub. No.: US 2025/0362512 A1
(43) Pub. Date: Nov. 27, 2025

(54) Apparatus for Providing Waveguide Displays with Two-Dimensional Pupil Expansion

(71) Applicant: DigiLens Inc., Sunnyvale, CA (US)

(72) Inventors: Milan Momcilo Popovich, Leicester (GB); Jonathan David Waldern, Diablo, CA (US); Alastair John Grant, San Jose, CA (US)

(73) Assignee: DigiLens Inc., Sunnyvale, CA (US)

(21) Appl. No.: 19/292,818

(22) Filed: Aug. 6, 2025

Related U.S. Application Data
(63) Continuation of application No. 18/465,091, filed on Sep. 11, 2023, now Pat. No. 12,405,471.
Application No. 18/465,091 is a continuation of application No. 17/655,756, filed on Mar. 21, 2022, now Pat. No. 11,754,842.
Application No. 17/655,756 is a continuation of application No. 17/118,285, filed on Dec. 10, 2020, now Pat. No. 11,281,013.
Application No. 17/118,285 is a continuation of application No. 16/806,947, filed on Mar. 2, 2020, now abandoned.
Application No. 16/806,947 is a continuation of application No. 15/765,243, filed on Mar. 30, 2018, now Pat. No. 10,690,916.
(60) Provisional application No. 62/284,603, filed on Oct. 5, 2015.
(60) Provisional application No. 62/285,275, filed on Oct. 23, 2015.

(51) Int. Cl. G02B 27/01; F21V 8/00; G02B 5/18; G02B 27/00; G02F 1/29

(52) U.S. Cl. CPC G02B 27/0172; G02B 5/1866; G02B 6/0016; G02B 6/0035; G02B 6/0076; G02B 27/0081; G02B 27/0093; G02B 27/0179; G02F 1/292; G02B 2027/0114; G02B 2027/0125; G02B 2027/0187

(57) ABSTRACT

An optical display comprises: a first waveguide comprising a first surface and a second surface, an input coupler, a fold grating, and an output grating. The input coupler receives collimated first wavelength light from an Input Image Node causes the light to travel within the first waveguide via total internal reflection between the first surface and the second surface to the fold grating. The fold grating provides pupil expansion in a first direction directs the light to the output grating via total internal reflection between the first surface and the second surface. The output grating provides pupil expansion in a second direction different than the first direction and causes the light to exit the first waveguide from the first surface or the second surface. At least one of the input coupler, fold grating and output grating is a rolled k-vector grating, and the fold grating is a dual interaction grating.

### CROSS-REFERENCE TO RELATED APPLICATIONS

This current application is a continuation of U.S. patent application Ser. No. 18/465,091, entitled “Apparatus for Providing Waveguide Displays with Two-Dimensional Pupil Expansion”, filed Sep. 11, 2023 and published as US 2024-0255760 A1 on Aug. 1, 2024, which is a continuation of U.S. patent application Ser. No. 17/655,756, entitled “Apparatus for Providing Waveguide Displays with Two-Dimensional Pupil Expansion,” filed Mar. 21, 2022 and published as US 2022-0260838 A1 on Aug. 18, 2022, which application is a continuation of U.S. patent application Ser. No. 17/118,285, entitled “Apparatus for Providing Waveguide Displays with Two-Dimensional Pupil Expansion,” filed Dec. 10, 2020 and published as US 2021-0239984 A1 on Aug. 5, 2021, which application is a continuation of U.S. patent application Ser. No. 16/806,947, entitled “Apparatus for Providing Waveguide Displays with Two-Dimensional Pupil Expansion,” filed Mar. 2, 2020 and published as US 2020-0201051 A1 on Jun. 25, 2020, which application is a continuation of U.S. patent application Ser. No. 15/765,243, entitled “Apparatus for Providing Waveguide Displays with Two-Dimensional Pupil Expansion,” filed Mar. 30, 2018 and published as US 2018-0284440 A1 on Oct. 4, 2018, which application is a national stage of PCT Application No. PCT/GB2016/000181, entitled “Waveguide Display,” filed Oct. 4, 2016 and published as WO/2017/060665 on Apr. 13, 2017, which application claims priority to U.S. Provisional Patent Application No. 62/284,603 entitled Waveguide Display filed on Oct. 5, 2015 and U.S. Provisional Patent Application No. 62/285,275 entitled Waveguide Displays filed on Oct. 23, 2015, the disclosures of which are incorporated herein by reference in their entireties.

### BACKGROUND OF THE INVENTION

The present disclosure relates to displays including but not limited to near eye displays and more particularly to holographic waveguide displays.

Waveguide optics is currently being considered for a range of display and sensor applications for which the ability of waveguides to integrate multiple optical functions into a thin, transparent, lightweight substrate is of key importance. This new approach is stimulating new product developments including near-eye displays for Augmented Reality (AR) and Virtual Reality (VR), compact Heads Up Display (HUDs) for aviation and road transport and sensors for biometric and laser radar (LIDAR) applications. Waveguide displays have been proposed which use diffraction gratings to preserve eye box size while reducing lens size. U.S. Pat. No. 4,309,070 issued to St. Leger Searle and U.S. Pat. No. 4,711,512 issued to Upatnieks disclose substrate waveguide head up displays where the pupil of a collimating optical system is effectively expanded by the waveguide structure. U.S. patent application Ser. No. 13/869,866 discloses holographic wide angle displays and U.S. patent application Ser. No. 13/844,456 discloses waveguide displays having an upper and lower field of view.

A common requirement in waveguide optics is to provide beam expansion in two orthogonal directions. In display applications this translates to a large eyebox. While the principles of beam expansion in holographic waveguides are well established dual axis expansion requires separate grating layers to provide separate vertical and horizontal expansion. One of the gratings, usually the one giving the second axis expansion, also provides the near eye component of the display where the high transparency and thin, lightweight form factor of a diffractive optics can be used to maximum effect. In practical display applications, which demand full color and large fields of view the number of layers required to implement dual axis expansion becomes unacceptably large resulting in increased thickness weight and haze. Solutions for reducing the number of layers based on multiplexing two or more gratings in a single layer or fold gratings which can perform dual axis expansion (for a given angular range and wavelength) in a single layer are currently in development. Dual axis expansion is also an issue in waveguides for sensor applications such as eye trackers and LIDAR. There is a requirement for a low cost, efficient, compact dual axis expansion waveguide.

### SUMMARY OF THE INVENTION

It is a first object of the invention to provide a low cost, efficient, compact dual axis expansion waveguide.

The object of the invention is achieved in first embodiment of the invention in which there is provided an optical display, comprising: a first waveguide comprising a first surface and a second surface, an input coupler, a fold grating, and an output grating. The input coupler is configured to receive collimated first wavelength light from an Input Image Node (IIN) and to cause the light to travel within the first waveguide via total internal reflection between the first surface and the second surface to the fold grating. The fold grating is configured to provide pupil expansion in a first direction and to direct the light to the output grating via total internal reflection between the first surface and the second surface. The output grating is configured to provide pupil expansion in a second direction different than the first direction and to cause the light to exit the first waveguide from the first surface or the second surface. At least one of the input coupler, the fold grating or the output grating is a rolled k-vector grating. The light undergoes a dual interaction with the fold grating.

In some embodiments the IIN comprises a light source, a microdisplay for displaying image pixels and collimation optics. The IIN projects the image displayed on the microdisplay panel such that each image pixel is converted into a unique angular direction within the first waveguide

In some embodiments at least one of the gratings is switchable between a diffracting and non-diffracting state.

In some embodiments the optical display further comprises a second waveguide comprising a first surface and a second surface, an input coupler, a fold grating, and an output grating, wherein the input coupler is configured to receive collimated second wavelength light from the IIN.

In some embodiments at least one of the input coupler, the fold grating, and the output grating is a liquid crystal-based grating.

In some embodiments the first direction is orthogonal to the second direction.

In some embodiments the first direction is horizontal and the second direction is vertical.

In some embodiments the optical display further comprises an eye tracker.

In some embodiments the optical display further comprises a dynamic focus lens disposed in the IIN.

In some embodiments the optical display further comprises a dynamic focus lens disposed in proximity to the first or second surface of the first waveguide.

In some embodiments the first waveguide further comprises a first optical interface the IIN further comprises a second optical interface wherein the first and second optical interface can be decoupled by one of a mechanical mechanism or a magnetic mechanism.

In some embodiments the first waveguide is disposable. In some embodiments the first surface and the second surface are planar surfaces. In some embodiments the first surface and the second surface are curved surfaces. In some embodiments the IIN comprises a laser scanner.

In some embodiments the display provides one of a HMD, a HUD, an eye-slaved display, a dynamic focus display or a light field display.

In some embodiments at least one of the input coupler, fold grating and output grating multiplexes at least one of color or angle.

In some embodiments the optical display further comprises a beam homogenizer.

In some embodiments the display includes at least one optical traversing a gradient index image transfer waveguide.

In some embodiments the optical display further comprises a dichroic filter disposed between the input grating regions of the first and second waveguides.

In some embodiments the IIN further comprises a spatially-varying numerical aperture component for providing a numerical aperture variation along a direction corresponding to the field of view coordinate diffracted by the input coupler.

In some embodiments the spatially-varying numerical aperture component has at least one of diffractive, birefringent, refracting or scattering characteristics.

In some embodiments the field of view coordinate is the horizontal field of view of the display.

In some embodiments a spatially varying-numerical aperture is provided by tilting a stop plane such that its normal vector is aligned perpendicular to the highest display field angle in the plane containing the field of view coordinate diffracted by the input coupler.

One exemplary embodiment of the disclosure relates to a near eye optical display. The near eye optical display includes a waveguide comprising a first surface and a second surface, an input coupler, a fold grating, and an output grating. The input coupler is configured to receive collimated light from a display source and to cause the light to travel within the waveguide via total internal reflection between the first surface and the second surface to the fold grating. The fold grating is configured to provide pupil expansion in a first direction and to direct the light to the output grating via total internal reflection between the first surface and the second surface. The output grating is configured to provide pupil expansion in a second direction different than the first direction and to cause the light to exit the waveguide from the first surface or the second surface.

Another exemplary embodiment of the disclosure relates to a method of displaying information. The method includes receiving collimated light in a waveguide having a first surface and a second surface; providing the collimated light to a fold grating via total internal reflection between the first surface and the second surface; providing pupil expansion in a first direction using the fold grating and directing the light to an output grating via total internal reflection between the first surface and the second surface; and providing pupil expansion in a second direction different than the first direction and causing the light to exit the waveguide from the first surface or the second surface.

Following below are more detailed descriptions of various concepts related to, and embodiments of, an inventive optical display and methods for displaying information. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes. A more complete understanding of the invention can be obtained by considering the following detailed description in conjunction with the accompanying drawings, wherein like index numerals indicate like parts. For purposes of clarity, details relating to technical material that is known in the technical fields related to the invention have not been described in detail.

### BRIEF DESCRIPTION OF THE DRAWINGS

FIG. 1 is a schematic cross section view of a waveguide display in one embodiment.

FIG. 2 is a schematic plan view of a waveguide display shown the disposition of the gratings in one grating layer in one embodiment.

FIG. 3 is a schematic plan view of a waveguide display shown the disposition of the gratings in two grating layers in one embodiment.

FIG. 4 is a schematic cross section view of a color waveguide display using one waveguide per color and two grating layers in each waveguide in one embodiment.

FIG. 5 is a schematic cross section view of a color waveguide display using one waveguide per color and one grating layer in each waveguide in one embodiment.

FIG. 6 is a schematic plan view of a waveguide display showing an input grating a fold grating and an output grating in one embodiment.

FIG. 7 is a cross section view of an eye tracked near eye display according to the principles of the invention in one embodiment.

FIG. 8 is a cross section view of an eye tracked near eye display incorporating a dynamic focus lens in one embodiment.

FIG. 9 is a cross section view of an eye tracked near eye display incorporating a dynamic focus lens in one embodiment.

FIG. 10A is a schematic plan view of a first operational state display comprising a waveguide that can be decoupled from the IIN in one embodiment.

FIG. 10B is a schematic plan view of a second operational state display comprising a waveguide that can be decoupled from the IIN in one embodiment.

FIG. 11A is a rolled K-vector grating providing stepwise changes in K-vector direction in one embodiment.

FIG. 11B is a rolled K-vector grating providing continuous changes in K-vector direction in one embodiment.

FIG. 12A is front view of a waveguide display eyepiece in one embodiment.

FIG. 12B is plan view of a waveguide display eyepiece in one embodiment.

FIG. 12C is side view of a waveguide display eyepiece in one embodiment.

FIG. 12D is a three dimensional view of a waveguide display eyepiece in one embodiment.

FIG. 13A is a three dimensional view of a waveguide display implemented in a motorcycle helmet in one embodiment.

FIG. 13B is another three dimensional view of a waveguide display implemented in a motorcycle helmet in one embodiment.

FIG. 14 is a schematic cross section view of a reflective microdisplay input image node containing a spatially-varying numerical aperture component in one embodiment.

FIG. 15 is a schematic cross section view of a reflective microdisplay input image node containing a spatially-varying numerical aperture component in one embodiment.

FIG. 16 is a schematic cross section view of a transmissive microdisplay input image node containing a spatially-varying numerical aperture component in one embodiment.

FIG. 17 is a schematic cross section view of an emissive microdisplay input image node containing a spatially-varying numerical aperture component in one embodiment.

FIG. 18A is a schematic cross section view of a spatially-varying numerical aperture component based on a wedge prism in one embodiment.

FIG. 18B is a schematic cross section view of a spatially-varying numerical aperture component based on a wedge prism with one curved surface in one embodiment.

FIG. 18C is a schematic cross section view of a spatially-varying numerical aperture component based on an array of prisms in one embodiment.

FIG. 18D is a schematic cross section view of a spatially-varying numerical aperture component based on an array of lenses in one embodiment.

FIG. 19A is a schematic cross section view of a spatially-varying numerical aperture component based on an array of scattering elements in one embodiment.

FIG. 19B is a schematic cross section view of a spatially-varying numerical aperture component based on a substrate with a continuously varying scattering function in one embodiment.

FIG. 19C is a schematic cross section view of a spatially-varying numerical aperture component based on a substrate with a continuously varying birefringence tensor in one embodiment.

FIG. 19D is a schematic cross section view of a spatially-varying numerical aperture component based on an array of grating elements in one embodiment.

FIG. 20 is a schematic cross section view of an optical arrangement for providing varying numerical aperture across a pupil using a tilted pupil plane in one embodiment.

FIG. 21A is a three dimensional view of a first operational state of a wearable display comprising a retractable waveguide in one embodiment.

FIG. 21B is a three dimensional view of a second operational state of a wearable display comprising a retractable waveguide in one embodiment.

FIG. 21C is a three dimensional view of a third operational state of a wearable display comprising a retractable waveguide in one embodiment.

FIG. 22A is front view of a waveguide component showing the input, fold and output gratings in one embodiment.

FIG. 22B is front view of a waveguide component showing the input, fold and output gratings in one embodiment.

FIG. 23 is front view of a waveguide component showing the input, fold and output gratings in one embodiment.

FIG. 24 is a three dimensional view of a near eye display showing a ray trace from the IIN and waveguide component up to the eye box in one embodiment.

FIG. 25A is a three dimensional view of a first operational state of a motorcycle display in one embodiment.

FIG. 25B is a three dimensional view of a second operational state of a motorcycle display in one embodiment.

### DETAILED DESCRIPTION OF THE INVENTION

The invention will now be further described by way of example only with reference to the accompanying drawings. It will apparent to those skilled in the art that the present invention may be practiced with some or all of the present invention as disclosed in the following description. For the purposes of explaining the invention well-known features of optical technology known to those skilled in the art of optical design and visual displays have been omitted or simplified in order not to obscure the basic principles of the invention. Unless otherwise stated the term “on-axis” in relation to a ray or a beam direction refers to propagation parallel to an axis normal to the surfaces of the optical components described in relation to the invention. In the following description the terms light, ray, beam and direction may be used interchangeably and in association with each other to indicate the direction of propagation of electromagnetic radiation along rectilinear trajectories. The term light and illumination may be used in relation to the visible and infrared bands of the electromagnetic spectrum. Parts of the following description will be presented using terminology commonly employed by those skilled in the art of optical design. It should also be noted that in the following description of the invention repeated usage of the phrase “in one embodiment” does not necessarily refer to the same embodiment.

Referring generally to the Figures, systems and methods relating to near-eye display or head up display systems are shown according to various embodiments. Holographic waveguide technology can be advantageously utilized in waveguides for helmet mounted displays or head mounted displays (HMDs) and head up displays (HUDs) for many applications, including military applications and consumer applications (e.g., augmented reality glasses, etc.). Switchable Bragg gratings (SBGs) may be used in waveguides to eliminate extra layers and to reduce the thickness of current display systems, including HMDs, HUDs, and other near eye displays and to increase the field of view by tiling images presented sequentially on a microdisplay. A larger exit pupil may be created by using fold gratings in conjunction with conventional gratings to provide pupil expansion on a single waveguide in both the horizontal and vertical directions. Using the systems and methods disclosed herein, a single optical waveguide substrate may generate a wider field of view than found in current waveguide systems. Diffraction gratings may be used to split and diffract light rays into several beams that travel in different directions, thereby dispersing the light rays.

The grating used in the invention is desirably a Bragg grating (also referred to as a volume grating). Bragg gratings have high efficiency with little light being diffracted into higher orders. The relative amount of light in the diffracted and zero order can be varied by controlling their refractive index modulation of the grating, a property which is used to make lossy waveguide gratings for extracting light over a large pupil. One important class of gratings is known as Switchable Bragg Gratings (SBG). SBGs are fabricated by first placing a thin film of a mixture of photopolymerizable monomers and liquid crystal material between parallel glass plates. One or both glass plates support electrodes, typically transparent indium tin oxide films, for applying an electric field across the film. A volume phase grating is then recorded by illuminating the liquid material (often referred to as the syrup) with two mutually coherent laser beams, which interfere to form a slanted fringe grating structure. During the recording process, the monomers polymerize and the mixture undergoes a phase separation, creating regions densely populated by liquid crystal micro-droplets, interspersed with regions of clear polymer. The alternating liquid crystal-rich and liquid crystal-depleted regions form the fringe planes of the grating. The resulting volume phase grating can exhibit very high diffraction efficiency, which may be controlled by the magnitude of the electric field applied across the film. When an electric field is applied to the grating via transparent electrodes, the natural orientation of the LC droplets is changed causing the refractive index modulation of the fringes to reduce and the hologram diffraction efficiency to drop to very low levels. Typically, SBG Elements are switched clear in 30 μs. With a longer relaxation time to switch ON. Note that the diffraction efficiency of the device can be adjusted, by means of the applied voltage, over a continuous range. The device exhibits near 100% efficiency with no voltage applied and essentially zero efficiency with a sufficiently high voltage applied. In certain types of HPDLC devices magnetic fields may be used to control the LC orientation. In certain types of HPDLC phase separation of the LC material from the polymer may be accomplished to such a degree that no discernible droplet structure results. A SBG may also be used as a passive grating. In this mode its chief benefit is a uniquely high refractive index modulation.

SBGs may be used to provide transmission or reflection gratings for free space applications. SBGs may be implemented as waveguide devices in which the HPDLC forms either the waveguide core or an evanescently coupled layer in proximity to the waveguide. The parallel glass plates used to form the HPDLC cell provide a total internal reflection (TIR) light guiding structure. Light is coupled out of the SBG when the switchable grating diffracts the light at an angle beyond the TIR condition. Waveguides are currently of interest in a range of display and sensor applications. Although much of the earlier work on HPDLC has been directed at reflection holograms transmission devices are proving to be much more versatile as optical system building blocks. Typically, the HPDLC used in SBGs comprise liquid crystal (LC), monomers, photoinitiator dyes, and coinitiators. The mixture frequently includes a surfactant. The patent and scientific literature contains many examples of material systems and processes that may be used to fabricate SBGs. Two fundamental patents are: U.S. Pat. No. 5,942,157 by Sutherland, and U.S. Pat. No. 5,751,452 by Tanaka et al. Both filings describe monomer and liquid crystal material combinations suitable for fabricating SBG devices. One of the known attributes of transmission SBGs is that the LC molecules tend to align normal to the grating fringe planes. The effect of the LC molecule alignment is that transmission SBGs efficiently diffract P polarized light (ie light with the polarization vector in the plane of incidence) but have nearly zero diffraction efficiency for S polarized light (ie light with the polarization vector normal to the plane of incidence. Transmission SBGs may not be used at near-grazing incidence as the diffraction efficiency of any grating for P polarization falls to zero when the included angle between the incident and reflected light is small.

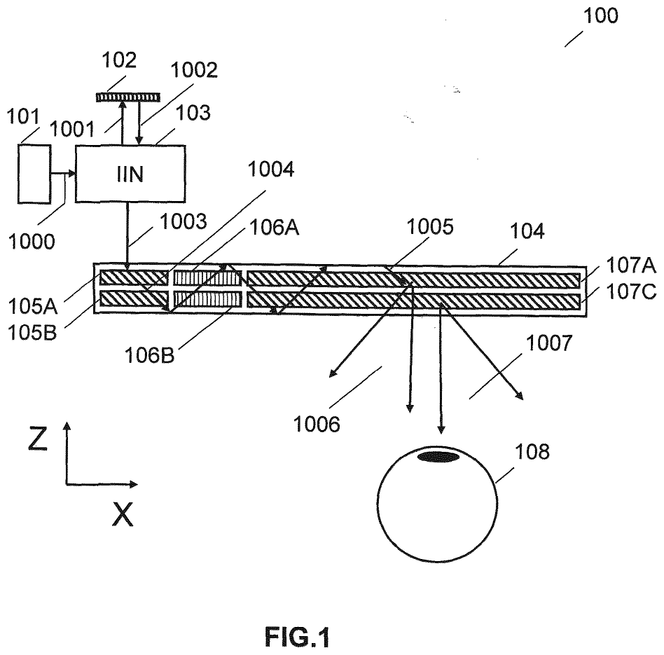

The object of the invention is achieved in first embodiment illustrated in FIG. 1 in which there is provided a dual axis expansion waveguide display 100 comprising a light source 101 a microdisplay panel 102 and an input image node (IIN) 103 optically coupled to a waveguide 104 comprise two grating layers 104A,104B. In some embodiments the waveguide is formed by sandwiched the grating layers between glass or plastic substrates to form a stack within which total internal reflection occurs at the outer substrate and air interfaces. The stack may further comprise additional layers such as beam splitting coatings and environmental protection layers. Each grating layer contains an input grating 105A,105B, a fold grating exit pupil expander 106A,106B and an output grating 107A, 107B where characters A and B refer to waveguide layers 104A,104B respectively. The input grating, fold grating and the output grating are holographic gratings, such as a switchable or non-switchable SBG. As used herein, the term grating may encompass a grating comprised of a set of gratings in some embodiments. In general the IIN integrates a microdisplay panel, light source and optical components needed to illuminate the display panel, separate the reflected light and collimate it into the required FOV. In the embodiment of FIG. 1 and in the embodiments to be described below at least one of the input fold and output gratings may be electrically switchable. In many embodiments it is desirable that all three grating types are passive, that is, non-switching. The IIN projects the image displayed on the microdisplay panel such that each display pixel is converted into a unique angular direction within the substrate waveguide according to some embodiments. The collimation optics contained in the IIN may comprise lens and mirrors which is some embodiments may be diffractive lenses and mirrors.

In some embodiments the IIN may be based on the embodiments and teachings disclosed in U.S. patent application Ser. No.: 13/869,866 entitled HOLOGRAPHIC WIDE ANGLE DISPLAY, and U.S. patent application Ser. No.: 13/844,456 entitled TRANSPARENT WAVEGUIDE DISPLAY. In some embodiments the IIN contains beamsplitter for directing light onto the microdisplay and transmitting the reflected light towards the waveguide. In one embodiment the beamsplitter is a grating recorded in HPDLC and uses the intrinsic polarization selectivity of such gratings to separate the light illuminating the display and the image modulated light reflected off the display. In some embodiments the beam splitter is a polarizing beam splitter cube. In some embodiment the IIN incorporates a despeckler. Advantageously, the despeckler is holographic waveguide device based on the embodiments and teachings of US Pat. No. US8, 565,560 entitled LASER ILLUMINATION DEVICE.

The light source can be a laser or LED and can include one or more lenses for modifying the illumination beam angular characteristics. The image source can be a micro-display or laser based display. LED will provide better uniformity than laser. If laser illumination is used there is a risk of illumination banding occurring at the waveguide output. In some embodiments laser illumination banding in waveguides can be overcome using the techniques and teachings disclosed in United States Provisional Patent Application No.: 62/071,277 entitled METHOD AND APPARATUS FOR GENERATING INPUT IMAGES FOR HOLOGRAPHIC WAVEGFUIDE DISPLAYS. In some embodiments, the light from the light source 101 is polarized. In one or more embodiments, the image source is a liquid crystal display (LCD) micro display or liquid crystal on silicon (LCoS) micro display.

The light path from the source to the waveguide via the IIN is indicated by rays 1000-1003. The input grating of each grating layer couples a portion of the light into a TIR path in the waveguide once such path being represented by the rays 1004-1005. The output waveguides 107A, 107C diffract light out of the waveguide into angular ranges of collimated light 1006,1007 respectively for viewing by the eye 108. The angular ranges, which correspond to the field of view of the display, are defined solely by the IIN optics. In some embodiments the waveguide gratings may encoded optical power for adjusting the collimation of the output. In some embodiments the output image is at infinity. In some embodiments the output image may be formed at distances of several meters from the eye box. Typically the eye is positioned within the exit pupil or eye box of the display.

In some embodiments similar to the one shown in FIG. 1 each grating layer addresses half the total field of view. Typically, the fold gratings are clocked (that is, tilted in the waveguide plane) at 45° to ensure adequate angular bandwidth for the folded light. However some embodiments of the invention may use other clock angles to satisfy spatial constraints on the positioning of the gratings that may arise in the ergonomic design of the display. In some embodiments at least one of the input and output gratings have rolled k-vectors. The K-vector is a vector aligned normal to the grating planes (or fringes) which determines the optical efficiency for a given range of input and diffracted angles. Rolling the K-vectors allows the angular bandwidth of the grating to be expanded without the need to increase the waveguide thickness.

In some embodiments the fold grating angular bandwidth can be enhanced by designing the grating prescription provides dual interaction of the guided light with the grating. Exemplary embodiments of dual interaction fold gratings are disclosed in U.S. patent application Ser. No.: 14/620,969 entitled WAVEGUIDE GRATING DEVICE.

It is well established in the literature of holography that more than one holographic prescription can be recorded into a single holographic layer. Methods for recording such multiplexed holograms are well known to those skilled in the art. In some embodiments at least one of the input, fold or output gratings may combine two or more angular diffraction prescriptions to expand the angular bandwidth. Similarly, in some embodiments at least one of the input, fold or output gratings may combine two or more spectral diffraction prescriptions to expand the spectral bandwidth. For example a color multiplexed grating may be used to diffract two or more of the primary colors.

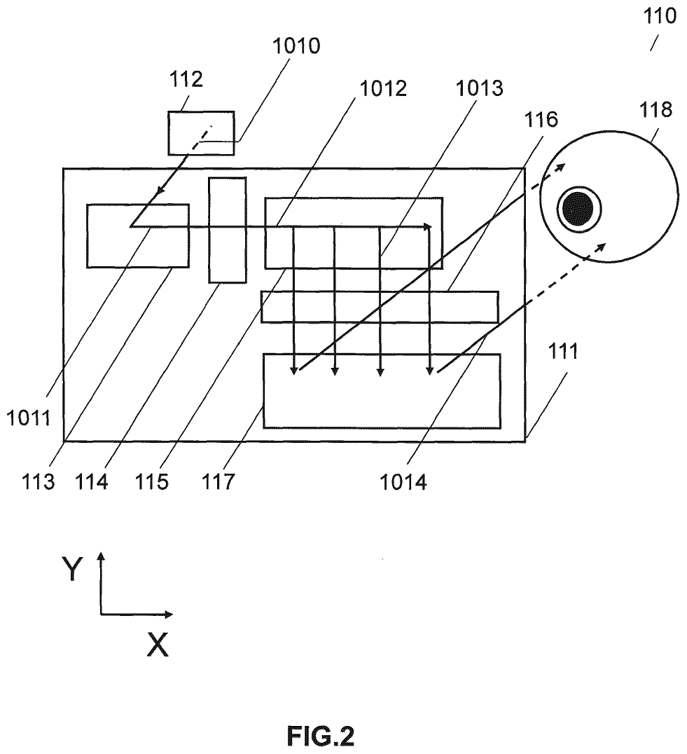

FIG. 2 is a plan view 110 of a single grating layer similar to the ones used in FIG. 1. The grating layer 111 which is optically coupled to the IIN 112 comprising input grating 113, a first beamsplitter 114, a fold grating 115, a second beamsplitter 116 and an output grating 117. The beamsplitter are partially transmitting coatings which homogenise the wave guided light by providing multiple reflection paths within the waveguide. Each beamsplitter may comprise more than one coating layer with each coating layer being applied to a transparent substrates. Typical beam paths from the IIN up to the eye 118 are indicated by the rays 1010-1014.

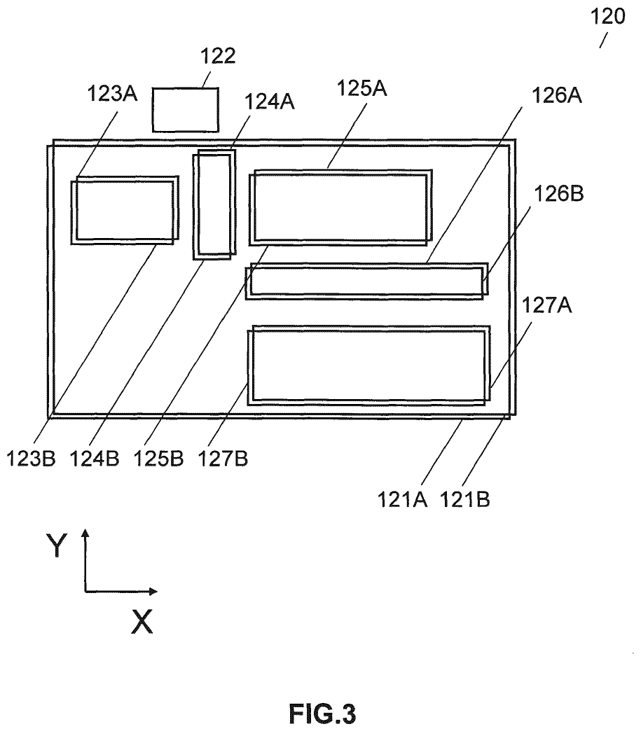

FIG. 3 is a plan view 110 of a two grating layer configuration similar to the ones used in FIG. 1 The grating layers 121A,121B which are optically coupled to the IIN 122 comprise input gratings 123A,123B, first beamsplitters 124A,124B, fold gratings 125A,125B, second beamsplitters 126A, 126B and output gratings 127A,127B, where the characters A,B refer to the first and second grating layers and the gratings and beams splitters of the two layers substantially overlap.

In the most waveguide configurations the input fold and output gratings are formed in a single layer sandwiched by transparent substrates. The embodiment of FIG. 1 has two such layers stacked. In some embodiments the waveguide may comprise just one grating layer. The substrates are not illustrated in FIG. 1 where the gratings are switching transparent electrodes are applied to opposing surfaces of the substrate layers sandwiching the switching grating. In some embodiments the cell substrates may be fabricated from glass. An exemplary glass substrate is standard Corning Willow glass substrate (index 1.51) which is available in thicknesses down to 50 micron. In other embodiments the cell substrates may be optical plastics.

In some embodiments the grating layer may be broken up into separate layers. For example, in some embodiments, a first layer includes the fold grating while a second layer includes the output grating. In some embodiments, a third layer can include the input grating. The number of layers may then be laminated together into a single waveguide substrate. In some embodiments, the grating layer is comprised of a number of pieces including the input coupler, the fold grating and the output grating (or portions thereof) that are laminated together to form a single substrate waveguide. The pieces may be separated by optical glue or other transparent material of refractive index matching that of the pieces. In another embodiment, the grating layer may be formed via a cell making process by creating cells of the desired grating thickness and vacuum filling each cell with SBG material for each of the input coupler, the fold grating and the output grating. In one embodiment, the cell is formed by positioning multiple plates of glass with gaps between the plates of glass that define the desired grating thickness for the input coupler, the fold grating and the output grating. In one embodiment, one cell may be made with multiple apertures such that the separate apertures are filled with different pockets of SBG material. Any intervening spaces may then be separated by a separating material (e.g., glue, oil, etc.) to define separate areas. In one embodiment the SBG material may be spin-coated onto a substrate and then covered by a second substrate after curing of the material. By using the fold grating, the waveguide display advantageously requires fewer layers than previous systems and methods of displaying information according to some embodiments. In addition, by using fold grating, light can travel by total internal refection within the waveguide in a single rectangular prism defined by the waveguide outer surfaces while achieving dual pupil expansion. In another embodiment, the input coupler, the fold grating and the output grating can be created by interfering two waves of light at an angle within the substrate to create a holographic wave front, thereby creating light and dark fringes that are set in the waveguide substrate 101 at a desired angle. In some embodiments the grating in a given layer is recorded in stepwise fashion by scanning or stepping the recording laser beams across the grating area. N some embodiments the gratings are recorded using mastering and contact copying process currently used in the holographic printing industry.

In one embodiment, the input coupler, the fold grating, and the output grating embodied as SBGs can be Bragg gratings recorded in a holographic polymer dispersed liquid crystal (HPDLC) (e.g., a matrix of liquid crystal droplets), although SBGs may also be recorded in other materials. In one embodiment, SBGs are recorded in a uniform modulation material, such as POLICRYPS or POLIPHEM having a matrix of solid liquid crystals dispersed in a liquid polymer. The SBGs can be switching or non-switching in nature. In its non switching form an SBG has the advantage over conventional holographic photopolymer materials of being capable of providing high refractive index modulation due to its liquid crystal component. Exemplary uniform modulation liquid crystal-polymer material systems are disclosed in United State Patent Application Publication No.: US2007/0019152 by Caputo et al and PCT Application No.: PCT/EP2005/006950 by Stumpe et al. both of which are incorporated herein by reference in their entireties. Uniform modulation gratings are characterized by high refractive index modulation (and hence high diffraction efficiency) and low scatter.

In one embodiment, the input coupler, the fold grating, and the output grating a reverse mode HPDLC material. Reverse mode HPDLC differs from conventional HPDLC in that the grating is passive when no electric field is applied and becomes diffractive in the presence of an electric field. The reverse mode HPDLC may be based on any of the recipes and processes disclosed in PCT Application No.: PCT/GB2012/000680, entitled IMPROVEMENTS TO HOLOGRAPHIC POLYMER DISPERSED LIQUID CRYSTAL MATERIALS AND DEVICES. The grating may be recorded in any of the above material systems but used in a passive (non-switching) mode. The fabrication process is identical to that used for switched but with the electrode coating stage being omitted. LC polymer material systems are highly desirable in view of their high index modulation. In some embodiments the gratings are recorded in HPDLC but are not switched.

In some embodiments the input grating may be replaced by another type of input coupler such as a prism, or reflective surface. In some embodiments, the input coupler can be a holographic grating, such as a switchable or non-switchable SBG grating. The input coupler is configured to receive collimated light from a display source and to cause the light to travel within the waveguide via total internal reflection between the first surface and the second surface to the fold grating. The input coupler may be orientated directly towards or at an angle relative to the fold grating. For example, in one embodiment, the input coupler may be set at a slight incline in relation to the fold grating.

In some embodiments, the fold grating may be oriented in a diagonal direction. The fold grating is configured to provide pupil expansion in a first direction and to direct the light to the output grating via total internal reflection inside the waveguide in some embodiments.

In one embodiment, a longitudinal edge of each fold grating is oblique to the axis of alignment of the input coupler such that each fold grating is set on a diagonal with respect to the direction of propagation of the display light. The fold grating is angled such that light from the input coupler is redirected to the output grating. In one example, the fold grating is set at a forty- five degree angle relative to the direction that the display image is released from the input coupler. This feature causes the display image propagating down the fold grating to be turned into the output grating. For example, in one embodiment, the fold grating causes the image to be turned 90 degrees into the output grating. In this manner, a single waveguide provides dual axis pupil expansion in both the horizontal and vertical directions. In one embodiment, each of the fold grating may have a partially diffractive structure.

In some embodiments, each of the fold gratings may have a fully diffractive structure. In some embodiments, different grating configurations and technologies may be incorporated in a single waveguide.

The output grating is configured to provide pupil expansion in a second direction different than the first direction and to cause the light to exit the waveguide from the first surface or the second surface. The output grating receives the display image from the fold grating via total internal reflection and provides pupil expansion in a second direction. In some embodiments, the output grating consists of multiple layers of substrate, thereby comprising multiple layers of output gratings. Accordingly, there is no requirement for gratings to be in one plane within the waveguide, and gratings may be stacked on top of each other (e.g., cells of gratings stacked on top of each other).

In some embodiments, a quarter wave plate on the substrate waveguide rotates polarization of a light ray to maintain efficient coupling with the SBGs. The quarter wave plate may be coupled to or adhered to the surface of substrate waveguide 101. For example, in one embodiment, the quarter wave plate is a coating that is applied to substrate waveguide. The quarter wave plate provides light wave polarization management. Such polarization management may help light rays retain alignment with the intended viewing axis by compensating for skew waves in the waveguide. The quarter wave plate is optional and can increase the efficiency of the optical design in some embodiments. In some embodiments, the waveguide does not include the quarter wave plate 142. The quarter wave plate may be provided as multi-layer coating.

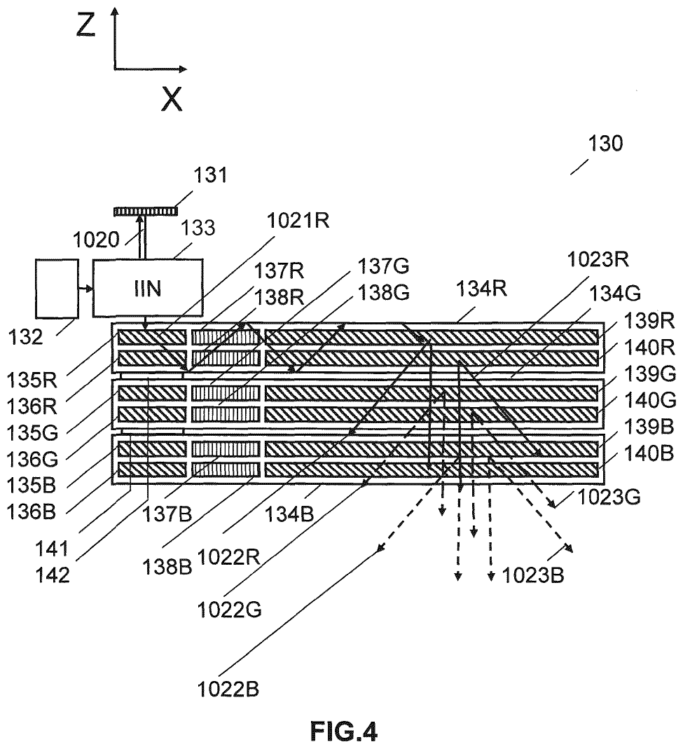

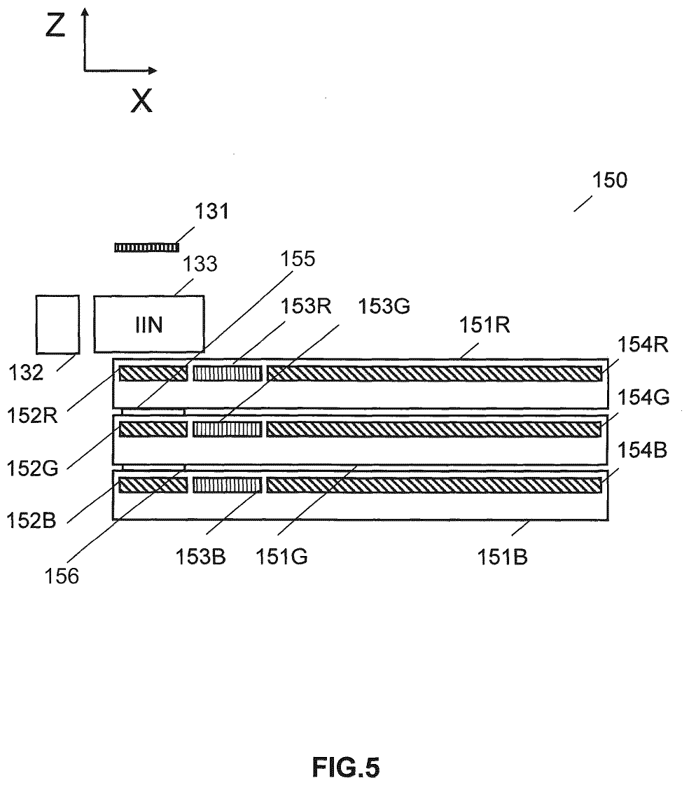

The embodiment of FIG. 1 would normally be operated in monochrome. A color would comprises a stack of monochrome waveguides of similar design to the one in FIG. 1. The design may use red green and blue waveguide layers as shown or, alternatively, red and blue/green layers. In the embodiment of FIG. 5 the dual axis expansion waveguide display 130 comprises a light source 132 a microdisplay panel 131 and an input image node (IIN) 133 optically coupled to red, green and blue waveguides 134R,134G,134B each comprise two grating layers. In order that wave guiding can take place in each waveguide the three waveguides are separated by air gaps. In some embodiments the waveguides are separated by a low index material such as a nanoporous film. The red grating layer labelled by R contains an input grating 135R,136R, a fold grating exit pupil expander 137R,138R and an output grating 139R,140R. The grating elements of the blue and green waveguides are labeled using the same numerals with B,G designating blue and red. Since the light paths through the IIN and waveguides in each of the red green and blue waveguides are similar to those illustrated in FIG. 1 they are nots shown in FIG. 4. In some embodiments the input, fold and output gratings are all passive, that is non-switching. In some embodiments at least one of the gratings is switching. In some embodiments the input gratings in each layer are switchable to avoid color crosstalk between the waveguide layers. In some embodiments color crosstalk is avoided by disposing dichroic filters 141,142 between the input grating regions of the red and blue and the blue and green waveguides.

In some embodiments a color waveguide based may use just one grating layer in each monochromatic waveguide. In the embodiment shown in FIG. 5, which is similar to the one of FIG. 4, the dual axis expansion waveguide display 150 comprises a light source 132, a microdisplay panel 131 and an input image node (IIN) 133 optically coupled to red, green and blue waveguides 151R,151G,151B each comprising one grating layer. The red grating layer labelled by R contains an input grating 152R, a fold grating exit pupil expander 153R and an output grating 154R. The grating elements of the blue and green waveguides are labeled using the same numerals with B,G designating blue and red. Dichroic filters 155,156 are disposed between the input grating regions of the red and blue and the blue and green waveguides to control color crosstalk. Since the light paths through the IIN and waveguides in each of the red green and blue waveguides are similar to those illustrated in FIG. 1 they are nots shown in FIG. 5.

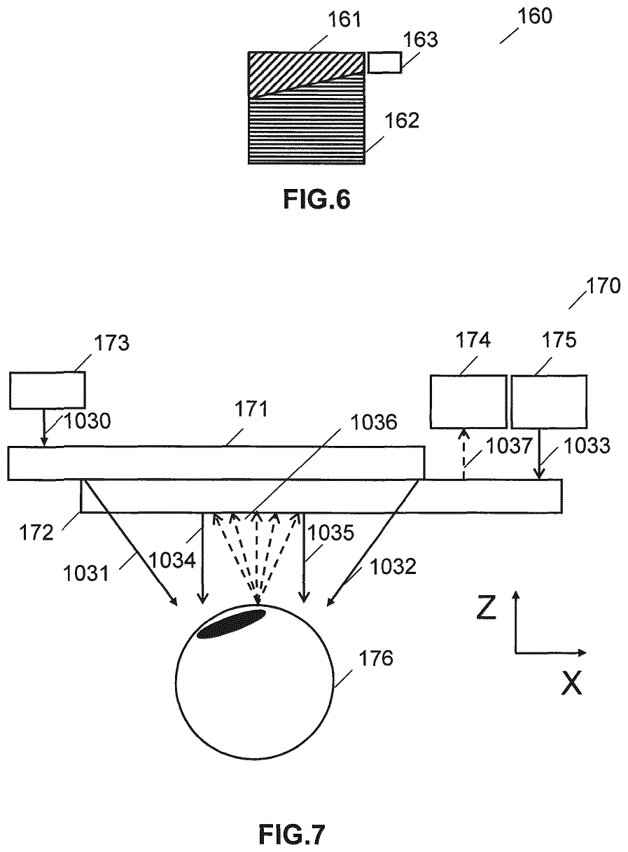

FIG. 6 is a plan view of a grating layer 160 in a waveguide display showing a layout comprising an input grating 163, a fold grating 162 and an output grating 163. Gratings are shaded using lines showing the orientations the grating fringes with the input grating fringes being aligned at 90 degrees to the X coordinate of the Cartesian reference frame shown, the fold grating fringes at 45 degrees and the output grating fringes at 0 degrees.

In one embodiment of the invention shown in FIG. 7 there is provided an eye tracked display comprising a waveguide display according to the principles of the invention and an eye tracker. In one preferred embodiment the eye tracker is a waveguide device based on the embodiments and teachings of PCT/GB2014/000197 entitled HOLOGRAPHIC WAVEGUIDE EYE TRACKER, PCT/GB2015/000274 entitled HOLOGRAPHIC WAVEGUIDE OPTICAL TRACKER, and PCT Application No.: GB2013/000210 entitled APPARATUS FOR EYE TRACKING. Turning again to FIG. 7 the eye tracked display 170 comprises a dual axis expansion waveguide display based on any of the above embodiments comprising the waveguide 171 containing at least one grating layer incorporating an input fold and output grating, the IIN 173, the eye tracker comprising the waveguide 173, infrared detector 174 and infrared source 175. The eye tracker and display waveguides are separate by an air gap or by a low refractive material. As is explained in the above references, the eye tracker may comprise separate illumination and detector waveguides. The optical path from the infrared source to the eye is indicated by the rays 1033-1035 and the backscattered signal from the eye is indicated by the rays 1036-1037. The display comprises a waveguide 966 and an input image node 968. The optical path from the input image node through the display waveguide to the eye box is indicated by the rays 1030-1032.

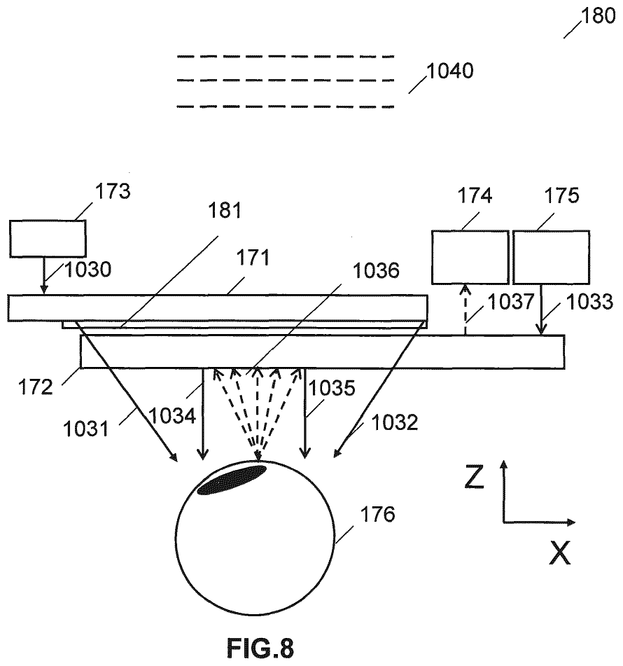

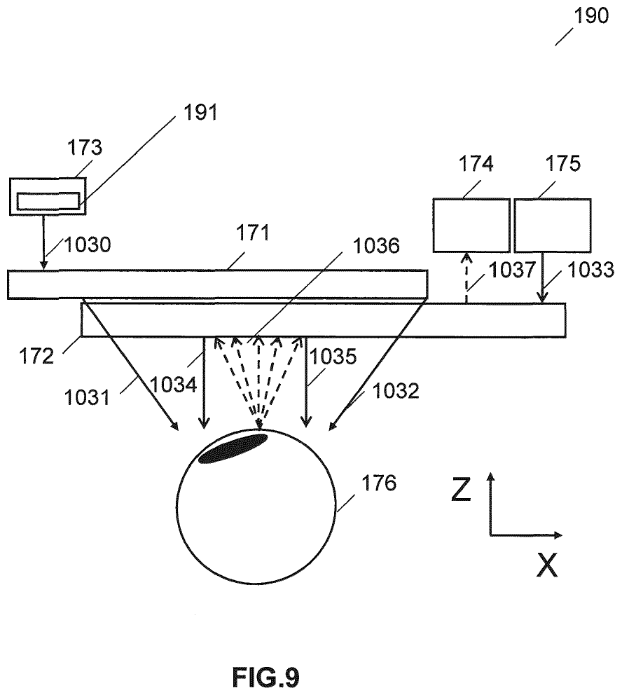

In some embodiments of the invention a dual expansion waveguide display further comprises a dynamic focusing element. In some embodiments such as the one shown in FIG. 8 a dual expansion waveguide display 180 further comprises a dynamic focusing element 181 disposed in proximity to a principal surface of the waveguide display and an eye tracker. Advantageously the dynamic focusing element is a LC device. In some embodiments the LC device combines an LC layer and a diffractive optical element. In some embodiments the diffractive optical element is an electrically controllable LC-based device. In some embodiments the dynamic focusing element is disposed between the waveguide display and the eye tracker. In some embodiments the dynamic focusing element may be disposed in proximity to the surface of the display waveguide furthest from the eye. In some embodiments such as the one illustrated in FIG. 9 the dual expansion waveguide display 190 includes a dynamic focusing element 191 disposed within the IIN The effect of the dynamic focus device is to provide a multiplicity of image surfaces 1040. In light field display applications at least four image surfaces are required. The dynamic focusing element may be based on the embodiments and teachings of United States Provisional Patent Application No.: 62/176,572 entitled ELECTRICALLY FOCUS TUNABLE LENS. In some embodiment a dual expansion waveguide display further comprising a dynamic focusing element and an eye tracker may provide a light field display based on the embodiments and teachings disclosed in United States Provisional Patent Application No.: 62/125,089 entitled HOLOGRAPHIC WAVEGUIDE LIGHT FIELD DISPLAYS.

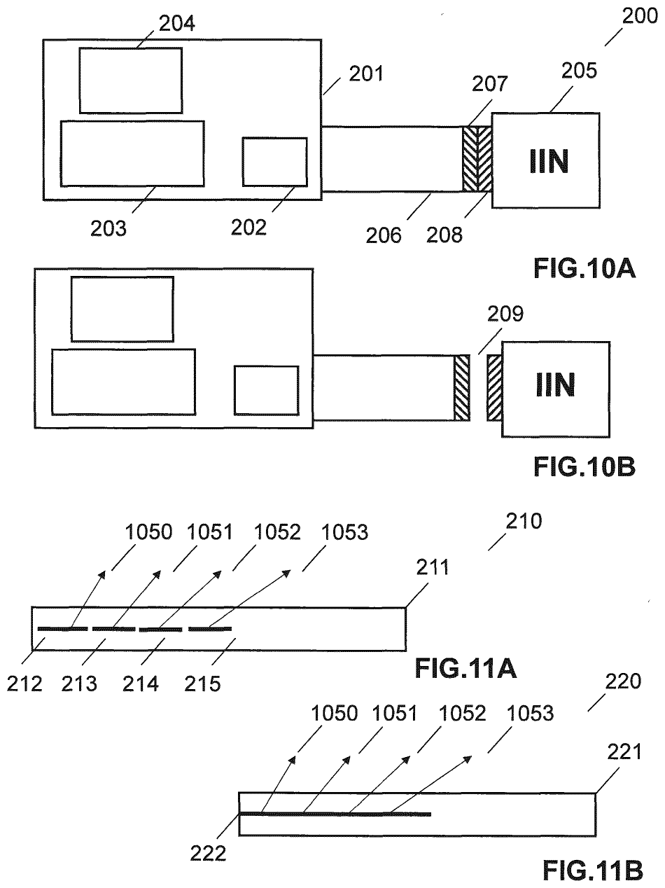

In some embodiments the waveguide display is coupled to the IIN by an opto-mechanical interface that allows the waveguide to be easily retracted from the IIN assembly. The basic principle is illustrated in FIG. 10A which shows a dual axis expansion waveguide display 200 comprising the waveguide 201 containing the input grating 202, fold grating 203 and output grating 204 and the IIN 205. The apparatus further comprises an optical link 206 connected to the waveguide, a first optical interface 207 terminating the optical link and a second optical interface 208 forming the exit optical port of the IIN. The first and second optical interfaces can be decoupled as indicated by the gap 209 shown in FIG. 10B. In some embodiments the optical link is a waveguide. In some embodiments the optical link is curved. In some embodiments the optical link is a GRIN image relay device. In some embodiments the optical connection is established using a mechanical mechanism. In some embodiments the optical connection is established using a magnetic mechanism. The advantage of decoupling the waveguide from the IIN in helmet mounted display applications is that the near eye portion of the display be removed when not in used. In some embodiments where the waveguide comprises passive gratings the near eye optics can be disposable.

FIG. 11 illustrates rolled K-vector gratings for use with the invention. Referring first to FIG. 11A, in some embodiments a rolled K-vector grating 220 is implemented as a waveguide portion containing the discrete grating elements 212-215 having K-vectors 1050-1053. Referring next to FIG. 11B, in some embodiments a rolled K-vector grating 220 is implemented as a waveguide portion containing grating elements 222 within which the K-vectors undergoes a smooth monotonic variation in direction including the illustrated directions 1050-1053.

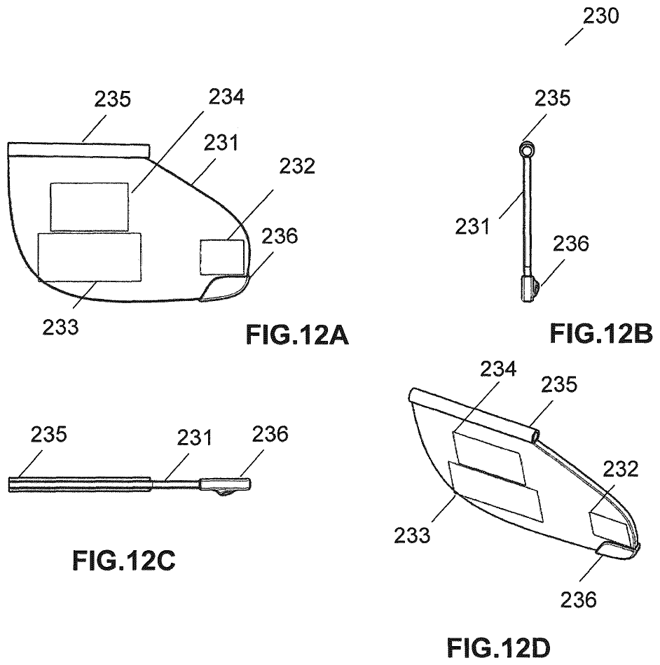

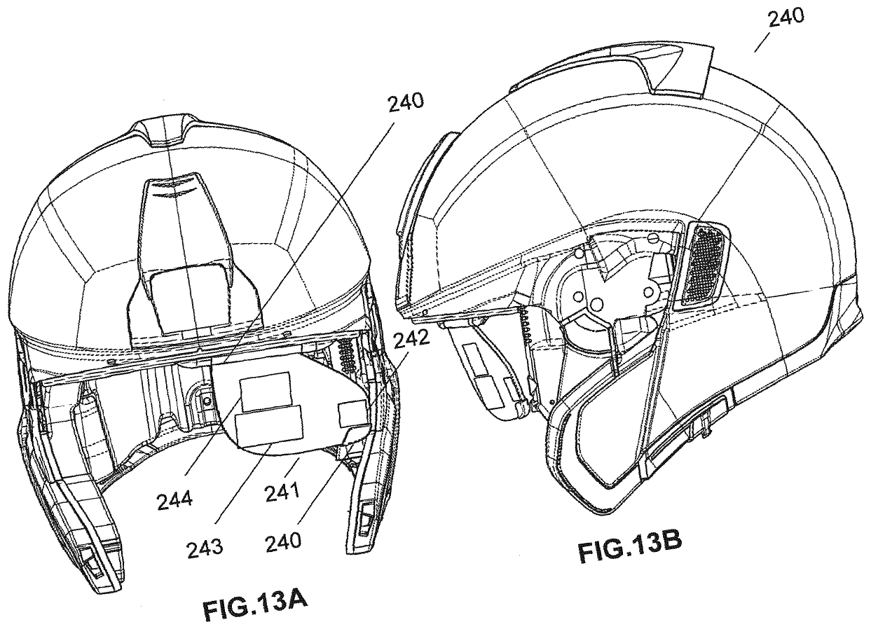

FIGS. 12A-12D illustrated front, plan, side and three dimensions views of one eyepiece of a dual axis expansion display used in a motorcycle helmet mount display in one embodiment. The display comprises the waveguide 231, input grating 232, fold grating 233, output grating 234, a hinge mechanism 235 for attaching the display to the helmet and the waveguide coupling mechanism 236. FIGS. 13A-FIG. 13B show three dimensional views of the eyepiece integrated in a motorcycle helmet.

In practical embodiments of the invention care must be taken to ensure that the IIN is optically matched to the waveguide. Waveguides raise optical interfacing issues that are not encountered in conventional optical systems in particular matching the input image angular content to the angular capacity of the waveguide and input grating. The optical design challenge is to match the IIN aperture variation as a function of field angle to the rolled K-vector input grating diffraction direction. Desirably the waveguide should be designed to make the waveguide thickness as small as possible while maximizing the spread of field angles at any given point on the input grating, subject to the limits imposed by the angular bandwidth of the input grating, and the angular carrying capacity of the waveguide. From consideration of the above description and the teachings of earlier filings such it should be appreciated that coupling collimated angular image content over the full field of view and without significant non-uniformity of the illumination distribution across the pupil requires a numerical aperture (NA) variation ranging from high NA on one side of the microdisplay falling smoothly to a low NA at the other side. For the purposes of explaining the invention the NA is defined as being proportional to the sine of the maximum angle of the image ray cone from a point on the microdisplay surface with respect to an axis normal to the microdisplay. Other equivalent measures may be used for the purposes of determining the most optimal IIN to waveguide coupling. Controlling the NA in this way will ensure high optical efficiency and reduced banding and other illumination non-homogeneities in the case of LED-illuminated displays. Laser-illuminated displays will also benefit from the control of NA variation across the microdisplay particular with regard to homogeneity.

The following embodiments address the problem of varying the NA. In one embodiment using angle selective coatings, gratings wedges, micro elements, freeform elements, etc, inside the IIN. We shall refer to the XYZ Cartesian coordinate system shown in the drawings. For the purposes of explain the invention the Z axis is normal to the waveguide and eyebox planes. The Y and X axes are vertical and horizontal respectively. The rolled-K vectors gratings have their K-vectors tilted in the X-Z plane. Image light in the waveguide propagates substantially in the X-direction. In the following paragraphs we shall describe schemes for varying the NA from high to low (or vice versa) across the horizontal axis of the microdisplay that is along the X-direction. In some embodiments the microdisplay is an LCoS device.

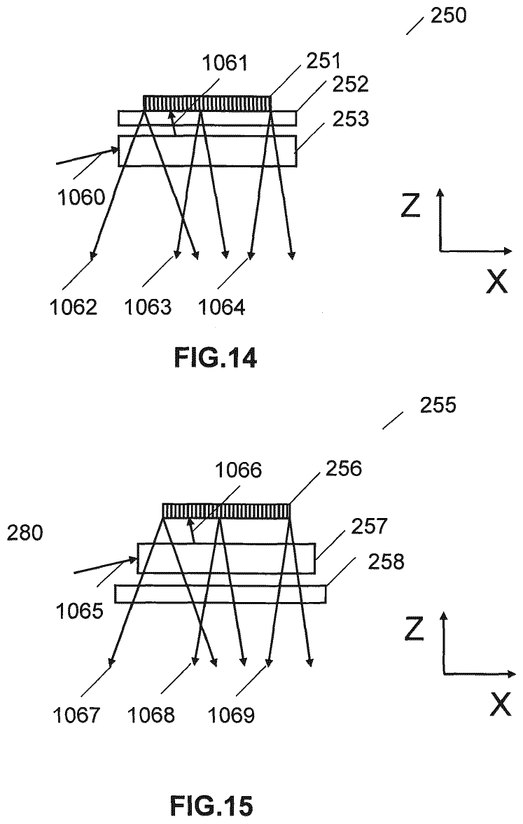

In one embodiment shown in FIG. 14 the IIN 250 comprises a microdisplay panel 251 a spatially-varying NA component 252 and microdisplay optics 253. The microdisplay optics accepts light 1060 from an illumination source which is not illustrated and deflects the light on to the microdisplay in the direction indicated by the ray 1061. The light reflected from the microdisplay is indicated by the divergent ray pairs 1062-1064 with NA angles varying along the X axis. In embodiments based on FIG. 14 the spatially-varying NA component is disposed between the microdisplay optics and the microdisplay. In some embodiments the spatially-varying NA component is disposed adjacent the output surface of the microdisplay optics as illustrated in FIG. 15 which shows a microdisplay 261, illumination component 262, spatially-varying NA component 263 with input illumination and illumination emitted from the microdisplay optics onto the microdisplay as indicated by the rays 1070,1071. The light reflected from the microdisplay is indicated by the divergent ray pairs 1072-1074 with NA angles varying along the X axis.

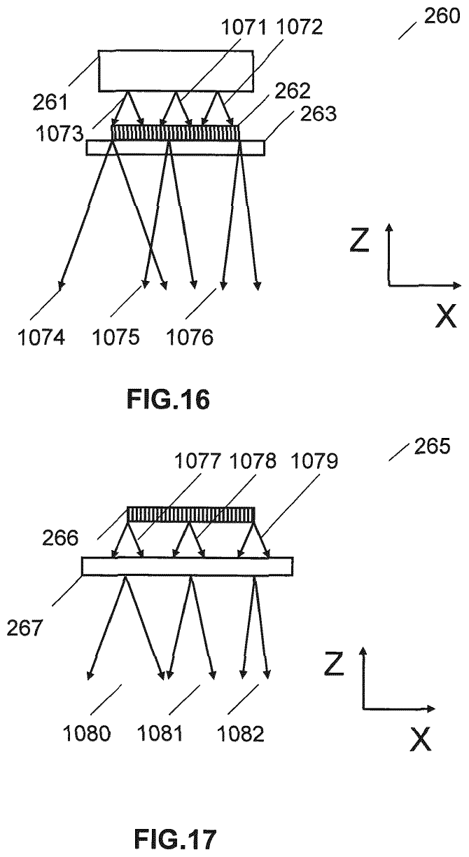

In the embodiments of FIGS. 14-15 the microdisplay is a reflective device. In some embodiments the microdisplay is a transmission device, typically a transmission LCoS device. In the embodiment of FIG. 16 the IIN 260 comprises the backlight 261, a microdisplay 262 and a variable NA component 263. Light from the backlight indicated by the rays 1071-1073 which typically has a uniform NA across the backlight illuminates the back surface of the microdisplay and after propagation through the variable NA component is converted into output image modulated light indicated by the divergent ray pairs 1072-1074 with NA angles varying along the X axis.

In some embodiments the principles of the invention may be applied to an emissive display. Examples of emissive displays for use with the invention include ones based on LED arrays and light emitting polymers arrays. In the embodiment of FIG. 17 the IIN 265 comprises an emissive microdisplay 266 and a spatially-varying NA component 267. Light from the microdisplay indicated by the rays 1077-1079 which typically has a uniform NA across the emitting surface of the display illuminates the spatially-varying NA component and is converted into output image modulated light indicated by the divergent ray pairs 1080-1082 with NA angles varying along the X axis.

The invention does not assume any particular design for the microdisplay optics. In some embodiments the microdisplay optics comprises a polarizing beam splitter cube. In some embodiments the microdisplay optics comprises an inclined plate to which a beam splitter coating has been applied. In some embodiments the microdisplay optics comprises a waveguide device comprising a SBG which acts as a polarization selective beam splitter based on some of the embodiments of U.S. patent application Ser. No.: 13/869,866 entitled HOLOGRAPHIC WIDE ANGLE DISPLAY, and U.S. patent application Ser. No.: 13/844,456 entitled TRANSPARENT WAVEGUIDE DISPLAY. In some embodiments the microdisplay optics contains at least one of a refractive component and curved reflecting surfaces or a diffractive optical element for controlling the numerical aperture of the illumination light. In some embodiments the microdisplay optics contains spectral filters for controlling the wavelength characteristics of the illumination light. In some embodiments the microdisplay optics contains apertures, masks, filter, and coatings for controlling stray light. In some embodiments the microdisplay optics incorporate birdbath optics.

We next describe exemplary embodiments of the spatially-varying NA component. In some embodiments the spatially-varying NA component has a uniformly varying NA characteristic. In some embodiments are provided in a stepwise fashion. It should be various exemplary embodiments of the spatially-varying NA component are illustrative only and, many modifications are possible (e.g., variations in sizes, dimensions, structures, shapes and proportions of the various elements, values of parameters, mounting arrangements, use of materials, orientations, etc.). For example, the position of elements may be reversed or otherwise varied and the nature or number of discrete elements or positions may be altered or varied.

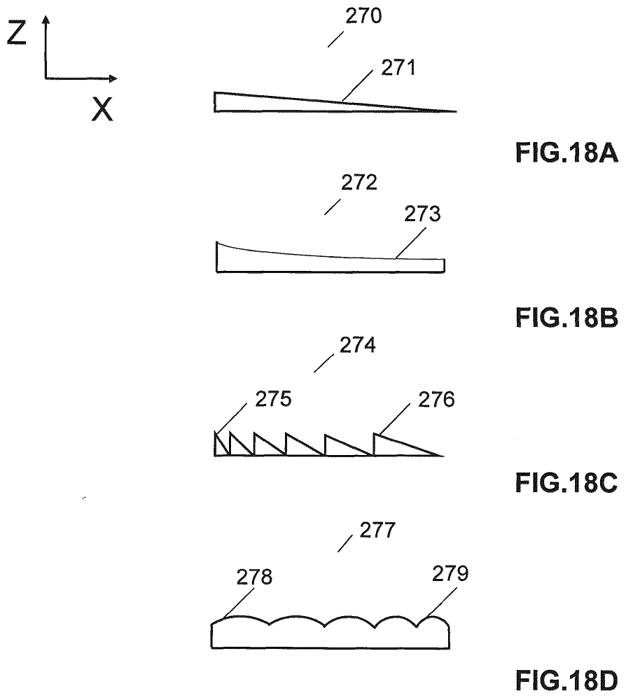

In some embodiments such as the one illustrated in illustrated in FIG. 18A a spatially-varying NA component 270 comprises a wedge 271. In some embodiments such as the one illustrated in FIG. 18B a spatially-varying NA component 272 comprises a wedge having a curved surface 273. In some embodiments such as the one illustrated in FIG. 18C a spatially-varying NA component 274 comprises an array of prismatic elements having differing prism angles such as the elements 275,276. In some embodiments such as the one illustrated in FIG. 18D a spatially-varying NA component 277 comprises an array of lenses having differing apertures and optical powers such as the lens elements indicated by 278,279.

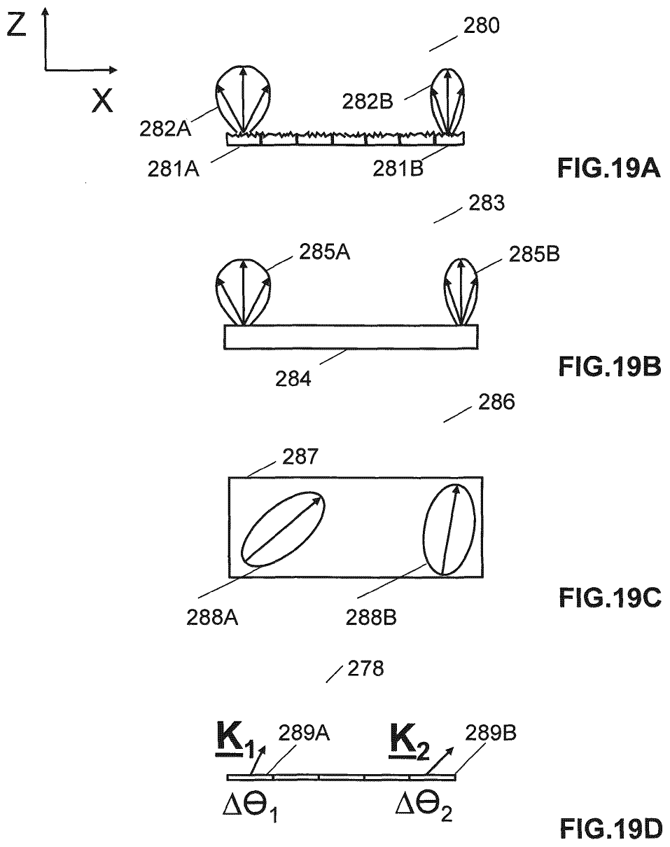

In some embodiments such as the one illustrated in FIG. 19A a spatially-varying NA component 280 comprises an array of scatter elements such as the elements 281A,281B providing differing scattered ray angular distributions such as the ones indicated by 282A,282B respectively. In some embodiments the scattering properties may be provided by surface textures applied to a substrate. In some embodiment the scattering properties may be provided by the bulk properties of the substrate. In some embodiments the substrate may contain particles suspended in a matrix of refractive index differing from that of the particle material. In some embodiments the substrate may be a PDLC material. In some embodiments such as the one illustrated in FIG. 19B a spatially-varying NA component 283 comprises a substrate 284 having a continuously varying scattering characteristics as indicated by the scattered ray angle distributions 285A,285B. The scattering properties may be provided by surface or bulk medium characteristics.

In some embodiments such as the one illustrated in FIG. 19C a spatially-varying NA component 286 comprises a birefringent substrate 287 having a spatially varying birefringence as represented by the uniaxial crystal index functions 288A, 288B. In some embodiments the substrate provides a continuous variation of birefringence. In some embodiments the substrates comprises discrete elements each have a unique birefringence. In some embodiments a spatially-varying NA component is a scattering substrate with birefringent properties. In some embodiments a spatially-varying NA component is based on any of the embodiments of FIGS. 18A-18D implements using a birefringent substrate. In some embodiments the NA variation across the field is performed using a birefringent layer having comprising a thin substrate coated with a Reactive Mesogen material. Reactive Mesogens are polymerizable liquid crystals comprising liquid crystalline monomers containing, for example, reactive acrylate end groups, which polymerize with one another in the presence of photo-initiators and directional UV light to form a rigid network. The mutual polymerization of the ends of the liquid crystal molecules freezes their orientation into a three dimensional pattern. Exemplary Reactive Mesogen materials are manufactured by Merck KgaA (Germany).

In some embodiments such as the one illustrated in FIG. 19D a spatially-varying NA component 286 comprises an array of diffractive elements each characterized by a unique K-vector and diffraction efficiency angular bandwidth. For example element 289A at one end of the component has k-vector K₁ and bandwidth Δ⊖₁ configured to provide a high NA while element 289B at the other end has k-vector K₂ and bandwidth Δ⊖₂ configured to provide a low NA. In some embodiments the grating characteristics vary continuously across the substrate. In some embodiments the gratings are Bragg holograms recorded in HPDLC materials. In some embodiments the gratings are surface relief gratings. In some embodiments the gratings are computer generated diffractive structures such as computer generated holograms (CGHs).

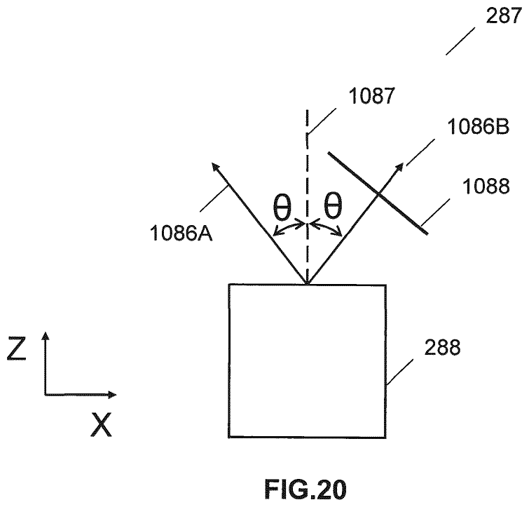

In some embodiments the IIN design addresses the NA variation problem, at least in part, by tilting the stop plane such that its normal vector is aligned parallel to the highest horizontal field angle, (rather than parallel to the optical axis). As illustrated in FIG. 20 the IIN 287 is configured to provide an output field of view of half angle ⊖ defined by the limiting rays 1086, 1086B disposed symmetrical about the optical axis 1087. The stop plane 1088 is normal to the limiting ray 1086B. It is assumed that the waveguide input grating, which is not illustrated, couples the horizontal field of view into the waveguide (not shown).

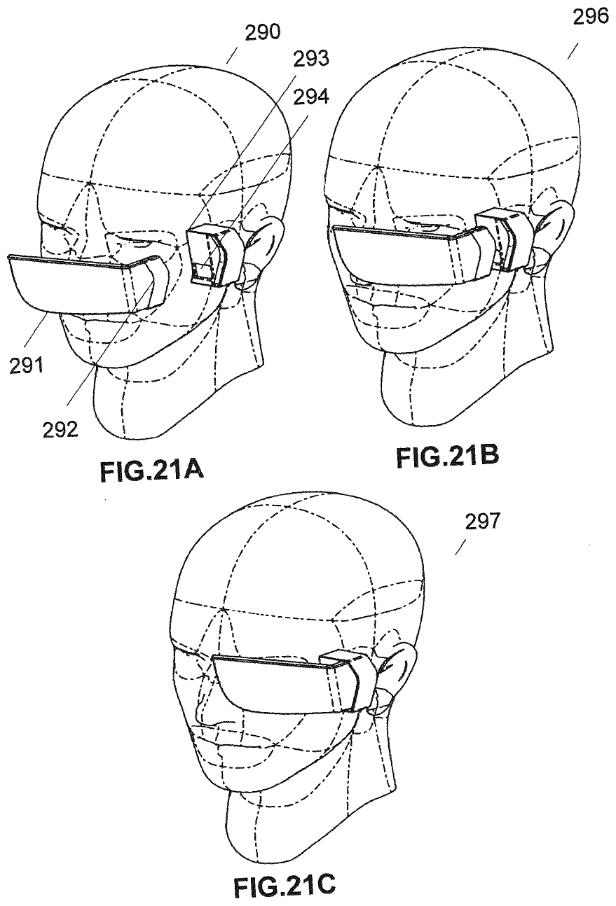

As discussed above, in some embodiments such as the one illustrated in FIG. 10 the waveguide display is coupled to the IIN by an opto-mechanical interface that allows the waveguide to be easily retracted from the IIN assembly. FIG. 21A shows a removable near eye display 290 comprising a near eye waveguide component and an IIN. The waveguide component includes an opto-mechanical interface for coupling to the IIN. The waveguide is shown retracted from the IIN assembly. FIG. 21B shows a second 3D view of the HMD 296 with the waveguide component retracted. FIG. 21C shows a 3D view of HMD 297 with the waveguide component and IIN connected and ready for use.

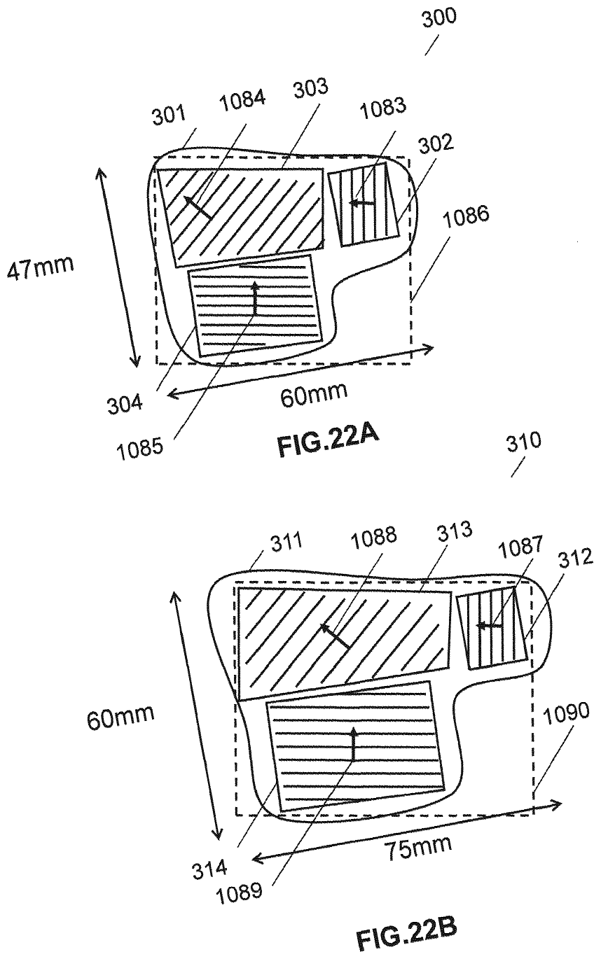

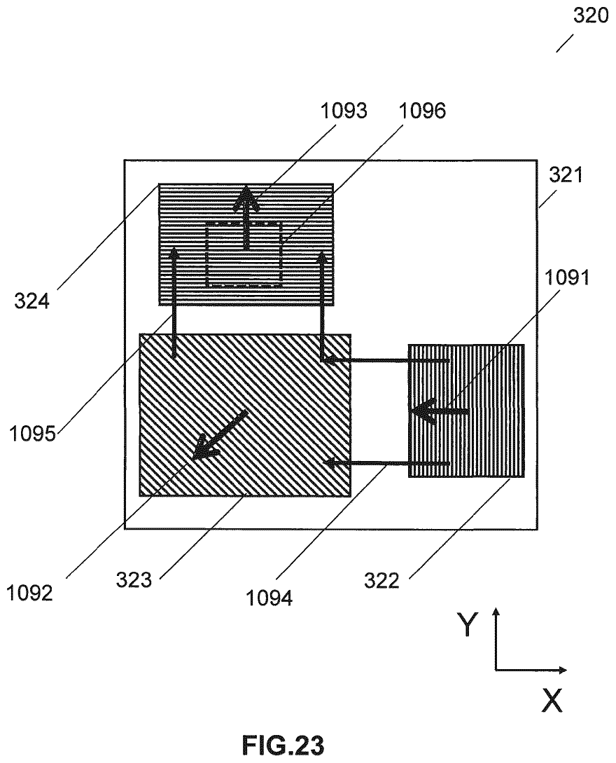

FIG. 22 show schematic front views of two waveguide grating layouts that may be provided by the invention. In the embodiment of FIG. 22A the waveguide 300 comprises a shaped waveguide comprising in a single layer indicted by 1086 an input grating 302, a fold grating 303 and an output grating 304. The K-vectors of the three gratings that is the normal vector to the fringes shown inside each grating are indicated by the 1083-1084. Not that in each case the K-vector is projected in the plane of the drawings. The overall dimensions of the waveguide are 60 mm. horizontal by 47 mm. vertical. In the embodiment of FIG. 22B the waveguide 310 comprises a shaped waveguide comprising in a single layer indicted by 1090 an input grating 313, a fold grating 314 and an output grating 315. The K-vectors of the three gratings that is the normal vector to the fringes shown inside each grating are indicated by the 1087-1089. In each case the K-vector is projected in the plane of the drawings. The overall dimensions of the waveguide are 75 mm. horizontal by 60 mm. vertical. FIG. 23 shows a further general waveguide grating layout that may be provided by the invention. The waveguide 320 comprises a rectangular waveguide comprising in a single layer an input grating 322, a fold grating 323 and an output grating 324. The K-vectors of the three gratings that is the normal vector to the fringes shown inside each grating are indicated by the 1091-1093. In each case the K-vector is projected in the plane of the drawings. The fold grating in this case has Bragg fringes aligned at 45 degrees in the plane of the grating.

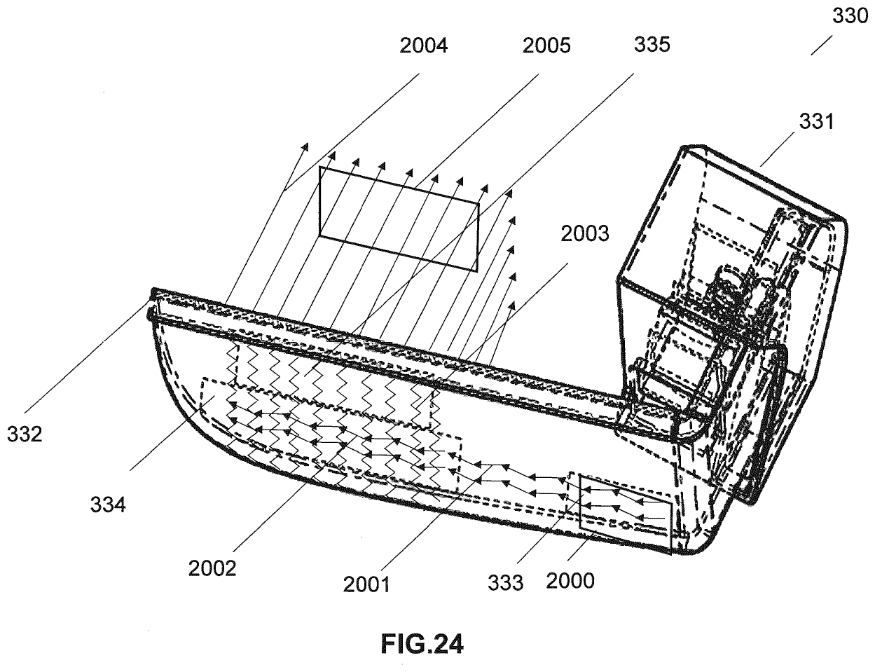

FIG. 24 is a 3D illustration of a near display comprising an IIN and waveguide component in one embodiment. The display 330 comprises an IIN 331, waveguide 332 containing in a single layer an input grating 33 a fold grating 334 and an output 335. The waveguide path from entrance pupil 2000 through the input grating, fold grating and output grating and up to the eye box 2005 is represented by the rays 2001-2004.

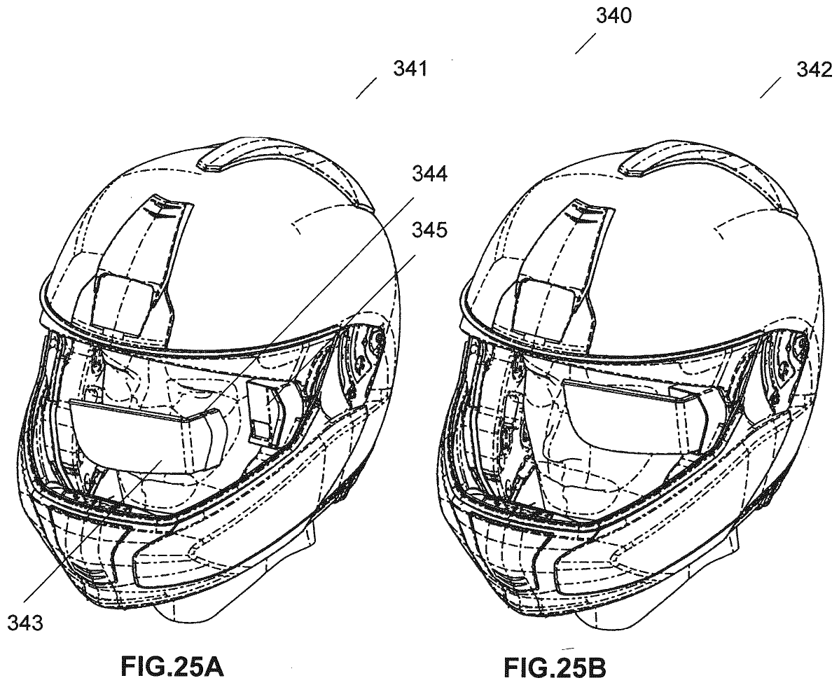

FIG. 25 is a 3D illustration of one embodiment in which there is provided a motorcycle HMD 340 using a near eye waveguide 343 with an opto-mechanical interface 344 for coupling to the IIN 345 which forms part of the helmet. The apparatus is similar to that illustrated in FIG. 21. FIG. 25A shows a first operational state 341 in which the waveguide component is fully retracted from the IIN assembly. FIG. 25B shows the display in its operational state 342 with the waveguide component connected to the IIN.

In some embodiments a dual expansion waveguide display according to the principles of the invention may be integrated within a window, for example, a windscreen-integrated HUD for road vehicle applications. In some embodiments a window-integrated display may be based on the embodiments and teachings disclosed in United States Provisional Patent Application No.: 62/125,064 entitled OPTICAL WAVEGUIDE DISPLAYS FOR INTEGRATION IN WINDOWS and United States Provisional Patent Application No.: 62/125,066 entitled OPTICAL WAVEGUIDE DISPLAYS FOR INTEGRATION IN WINDOWS. In some embodiments a dual expansion waveguide display may include gradient index (GRIN) wave-guiding components for relaying image content between the IIN and the waveguide. Exemplary embodiments are disclosed in United States Provisional Patent Application No.: 62/123,282 entitled NEAR EYE DISPLAY USING GRADIENT INDEX OPTICS and United States Provisional Patent Application No.: 62/124,550 entitled WAVEGUIDE DISPLAY USING GRADIENT INDEX OPTICS. In some embodiments a dual expansion waveguide display may incorporate a light pipe for providing beam expansion in one direction based on the embodiments disclosed in United States Provisional Patent Application No.: 62/177,494 entitled WAVEGUIDE DEVICE INCORPORATING A LIGHT PIPE. In some embodiments the input image source in the IIN may be a laser scanner as disclosed in U.S. Pat. No. 9,075,184 entitled COMPACT EDGE ILLUMINATED DIFFRACTIVE DISPLAY. The embodiments of the invention may be used in wide range of displays including HMDs for AR and VR, helmet mounted displays, projection displays, heads up displays (HUDs), Heads Down Displays, (HDDs), autostereoscopic displays and other 3D displays.

Some of the embodiments and teachings of this disclosure may be applied in waveguide sensors such as, for example, eye trackers, fingerprint scanners and LIDAR systems.

It should be emphasized that the drawings are exemplary and that the dimensions have been exaggerated. For example thicknesses of the SBG layers have been greatly exaggerated. Optical devices based on any of the above-described embodiments may be implemented using plastic substrates using the materials and processes disclosed in PCT Application No.: PCT/GB2012/000680, entitled IMPROVEMENTS TO HOLOGRAPHIC POLYMER DISPERSED LIQUID CRYSTAL MATERIALS AND DEVICES. In some embodiments the dual expansion waveguide display may be curved.

The construction and arrangement of the systems and methods as shown in the various exemplary embodiments are illustrative only. Although only a few embodiments have been described in detail in this disclosure, many modifications are possible (for example, variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

What is claimed is:

1. An optical display, comprising:
an input image node (IIN), configured to provide a collimated first wavelength image modulated light;
a first waveguide having a first surface and a second surface;
an input grating having a first k-vector, configured to receive the collimated first wavelength image modulated light and propagate the collimated first wavelength image modulated light within the first waveguide in total internal reflection between the first surface and the second surface of the first waveguide;
a fold grating having a second k-vector;
an output grating having a third k-vector; and
wherein the first, second and third gratings are formed using holographic recording into a single holographic recording material layer,
wherein the fold grating is configured to provide pupil expansion in a first direction and to direct the collimated first wavelength modulated light to the output grating via total internal reflection between the first surface and the second surface of the first waveguide,
wherein the output grating is configured to provide pupil expansion in a second direction different than the first direction and to propagate the collimated first wavelength image modulated light to exit the first waveguide.

2. The optical display of claim 1, wherein at least one of the first, second and third k-vectors has a projection into a plane parallel to a TIR surface of the waveguide different than the other k-vectors.

3. The optical display of claim 1, wherein at least one of the first, second and third k-vectors has a projection into a plane orthogonal to a TIR surface of the waveguide different than the other k-vectors.

4. The optical display of claim 1, wherein at least one of the input grating, the fold grating and the output grating are formed by phase separation of a mixture of monomer and an inert material under holographic exposure.

5. The optical display of claim 4, wherein where inert material is liquid crystal.

6. The optical display of claim 1, wherein a single holographic recording material layer after exposure comprises separately recorded input, fold and output gratings separated by index matching material.

7. The optical display of claim 1, wherein the light undergoes a dual interaction with the fold grating.

8. The optical display of claim 1, wherein the IIN comprises a light source, a microdisplay for displaying image pixels and collimation optics, and wherein the IIN projects the image displayed on the microdisplay panel such that each image pixel is converted into a unique angular direction within the first waveguide.

9. The optical display of claim 1, wherein at least one of the input grating, the fold grating and the output grating is switchable between a diffracting and non-diffracting state.

10. The optical display of claim 1, wherein the first surface and the second surface are planar surfaces.

11. The optical display of claim 1, wherein the first surface and the second surface are curved.

12. The optical display of claim 1, wherein the IIN comprises a laser scanner.

13. The optical display of claim 1, wherein the display provides one of a HMD, a HUD, an eye-slaved display, a dynamic focus display or a light field display.

14. The optical display of claim 1, wherein at least one of the input grating, fold grating and output grating multiplexes at least one of color or angle.

15. The optical display of claim 1, further comprising at least one selected from the group of a beam homogenizer eye tracker, and a gradient index image transfer component.

16. The optical display of claim 1, further comprising a second waveguide comprising a first surface and a second surface, an input grating, a fold grating, and an output grating, wherein the input grating is configured to receive collimated second wavelength light from the IIN.

17. The optical display of claim 16, further comprising a dichroic filter disposed between the input grating regions of the first and second waveguides.

18. The optical display of claim 1, wherein the IIN further comprises a spatially-varying numerical aperture component for providing a numerical aperture variation across the field of view of the optical display.

19. The optical display of claim 18, wherein a spatially varying-numerical aperture is provided by tilting a stop plane such that its normal vector is aligned parallel to the highest display field angle in the plane containing the field of view coordinate diffracted by the input grating.

20. The optical display of claim 1, wherein at least one of the input grating, the fold grating and the output grating are disposed within an evanescently coupled layer in proximity to the waveguide.

21. An optical display, comprising:
an input image node (IIN), configured to provide a collimated first wavelength image modulated light;
a waveguide having a first surface and a second surface;
an input grating having a first k-vector, configured to receive the collimated first wavelength image modulated light and propagate the collimated first wavelength image modulated light within the first waveguide in total internal reflection between the first surface and the second surface of the waveguide, wherein the input grating has a first grating fringe with a first slant angle;
a fold grating having a second k-vector, wherein the fold grating has a second grating fringe with a second slant angle;
an output grating having a third k-vector, configured to provide pupil expansion in a second direction different than the first direction and to propagate the collimated first wavelength image modulated light to exit the waveguide, wherein the output grating has a third grating fringe with a third slant angle; and
wherein at least one of the first slant angle, second slant angle, and third slant angle is different than the other slant angles,
wherein at least one of the first, second, and third k-vectors has a projection into a plane orthogonal to a TIR surface of the waveguide different than the other k-vectors,
wherein the input, fold and output gratings are formed using holographic recording into a single holographic recording material layer,
wherein the fold grating is configured to provide pupil expansion in a first direction and to direct the collimated first wavelength modulated light to the output grating via total internal reflection between the first surface and the second surface of the first waveguide.

22. The optical display of claim 21, wherein the input grating, the fold grating, and the output grating are discrete grating structures.

23. The optical display of claim 21, wherein the discrete grating structures provide a rolled k-vector.

24. The optical display of claim 22, wherein the input grating, the fold grating, and the output grating are spatially separated within the first waveguide.

25. The optical display of claim 21, wherein the input grating, the fold grating, and the output grating are a continuous grating having a rolled k-vector.

26. The optical display of claim 25, wherein the first, second, and third k-vectors provide the rolled k-vector.

27. The optical display of claim 1, wherein at least one of the input grating, the fold grating and the output grating are formed by phase separation of a mixture of monomer and an inert material under holographic exposure.

28. The optical display of claim 27, wherein where inert material is liquid crystal.

29. The optical display of claim 21, wherein the first surface and the second surface are planar surfaces.

30. The optical display of claim 21, wherein the first surface and the second surface are curved.

31. The optical display of claim 21, wherein the IIN comprises a laser scanner.

32. The optical display of claim 1, wherein the IIN further comprises a spatially-varying numerical aperture component for providing a numerical aperture variation across the field of view of the optical display.

33. The optical display of claim 32, wherein a spatially varying-numerical aperture is provided by tilting a stop plane such that its normal vector is aligned parallel to the highest display field angle in the plane containing the field of view coordinate diffracted by the input grating.

34. The optical display of claim 21, wherein the light undergoes a dual interaction with the fold grating.

35. The optical display of claim 21, wherein at least one of the input grating, the fold grating, and the output grating is a multiplexed grating.
